(19) United States
(12) Patent Application Publication
(10) Pub. No.: US 2007/0284786 A1
(43) Pub. Date: Dec. 13, 2007

(54) Method of Making Patterned Lace Ribbons

(76) Inventor: Jen-Chi Chang, Taichung (TW)

Correspondence Address: HDSL, 4331 STEVENS BATTLE LANE, FAIRFAX, VA, 22033, US

(21) Appl. No.: 11/423,496

(22) Filed: Jun. 12, 2006

(51) Int. Cl. B29C 59/16

(52) U.S. Cl. 264/444; 264/284; 264/160

(57) ABSTRACT

A method of making a patterned ribbon includes cutting a fabric to strips of ribbons, providing a roller device having a patterned model and a cutting blade, providing an ultrasonic device for high frequently oscillating and heating up the roller device, setting the ribbon under the roller device and driving the roller device to rotate and press the ribbon. The patterned model presses and melts corresponding regions of the ribbon to form a coining pattern on the ribbon according to the pattern of the patterned model. The heated cutting blade cuts down the excessive portion of the ribbon, and rapidly melts an edge of the ribbon for sealing.

### BACKGROUND

The present invention relates to a method of making patterned lace ribbons, and especially to a method of making patterned lace ribbons with coining patterns and sealing edges.

Conventional lace ribbons are knitted by a weft knitting, a weave knitting, or both. Theses methods need a large amount of time and induce a low production and a high cost.

What is needed, therefore, is a method of making a patterned lace ribbon, which improves the production of the lace ribbon

### BRIEF SUMMARY

A method of making a patterned ribbon has the steps of: cutting a fabric to strips of ribbons; providing a roller device, the roller device including a patterned model and a cutting blade; providing an ultrasonic device for high frequently oscillating and heating up the roller device; setting the ribbon under the roller device and driving the roller device to rotate and press the ribbon. The patterned model presses and melts corresponding regions of the ribbon to form a coining pattern on the ribbon according to the pattern of the patterned model. The heated cutting blade cuts down the excessive portion of the ribbon, and rapidly melts an edge of the ribbon for sealing.

The method of making a lace ribbon speeds up the production and reduces the cost. In addition, the method can produce all kinds of patterns on the patterned lace ribbon according to the requirements of customer by setting different patterned model on the roller device, which simplifies the manufacturing process.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view showing a step of cutting a lace fabric to strips of lace ribbons in a method of making a patterned lace ribbon according to a first embodiment of the present invention;

FIG. 2 is a schematic, cross-sectional view of a roller device used in the method of making a patterned lace ribbon;

FIG. 3 is a schematic, cross-sectional view of the roller device taken along a line of III-III of FIG. 2;

FIG. 4 is a schematic view showing an ultrasonic device electrically connecting with the roller device;

FIG. 5 is a schematic, top view showing a step of forming a coining pattern on the lace ribbon in the method of making a patterned lace ribbon;

FIG. 6 is a schematic view showing a patterned lace ribbon made by the method of FIG. 5; and

FIG. 7 is a schematic view showing an alternative patterned lace ribbon made by the method.

### DETAILED DESCRIPTION

Reference will now be made to the drawings to describe the preferred embodiments in detail.

A method of making a patterned lace ribbon according to a first embodiment of the present invention comprises the steps of as follows.

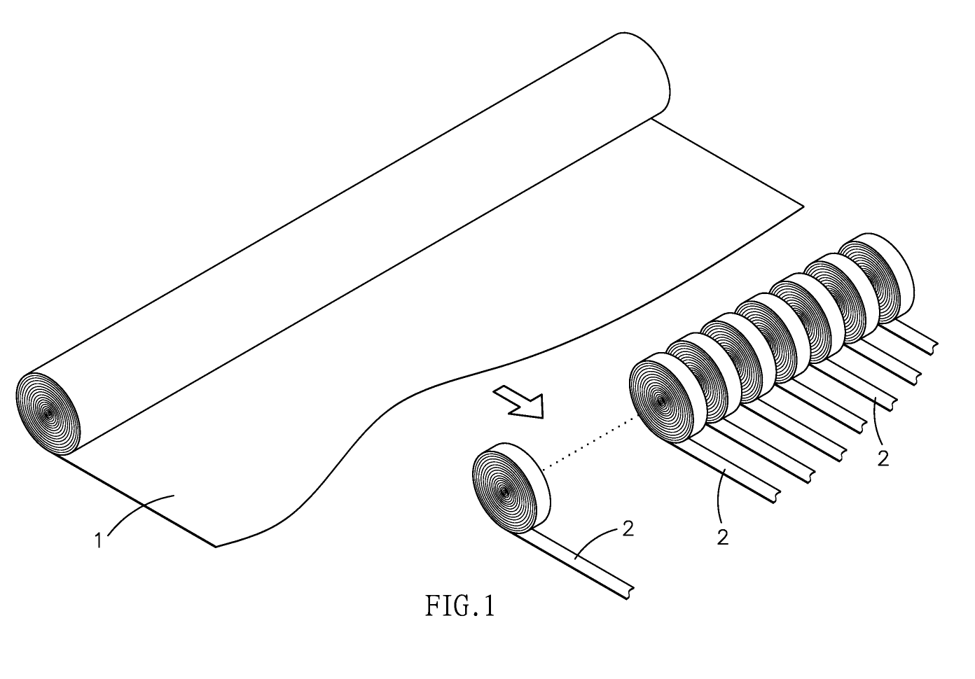

Step 1 (shown in FIG. 1): a lace fabric 1 is cut to strips of lace ribbons 2. The lace fabric has a predetermined width, and may be polyester, nylon, metallic or a material knitted by the both;

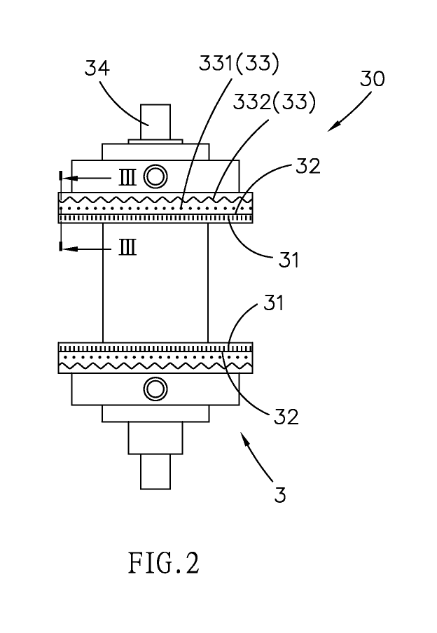

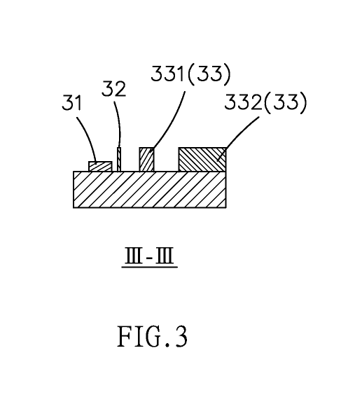

Step 2 (shown in FIG. 2 and FIG. 3): a roller device is provided, which has a roller bearing 34, two patterned press elements 30 set on two opposite ends of the roller bearing 34. Each pattern press element 30 has a patterned model 31, a cutting blade 32, and a protuberance assembly 33 for protecting the cutting blade 32 from damaging. The patterned model 31, the cutting blade 32, and the protuberance assembly 33 are orderly formed on a circumference surface of a ring-shaped base (not labeled), substantially parallel to each other. The patterned model 31 has a continuous pattern. The protuberance assembly 33 has a protruding wall 332, and a protruding pole 331 between the cutting blade 31 and the protruding wall 332.

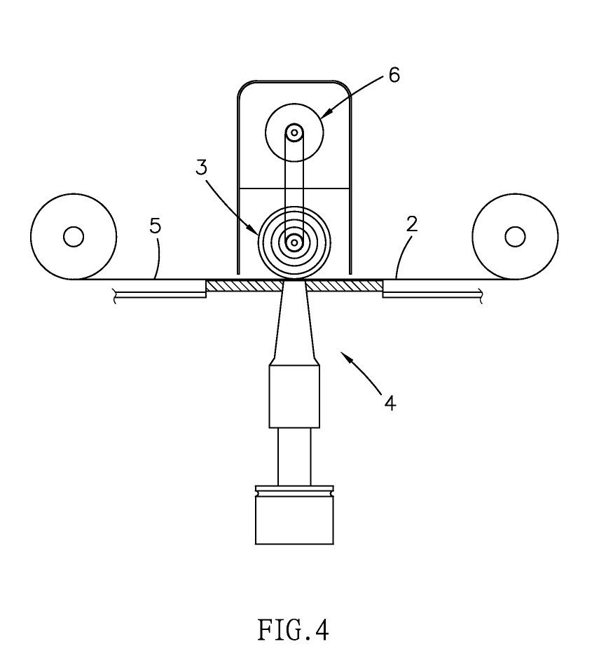

Step 3 (shown in FIG. 4): an ultrasonic device 4 is provided, which electrically connects with the roller device 3. When an electrical voltage is applied, the ultrasonic device 4 makes the roller device 3 high frequently oscillate and the roller device 3 is heated up to a high temperature.

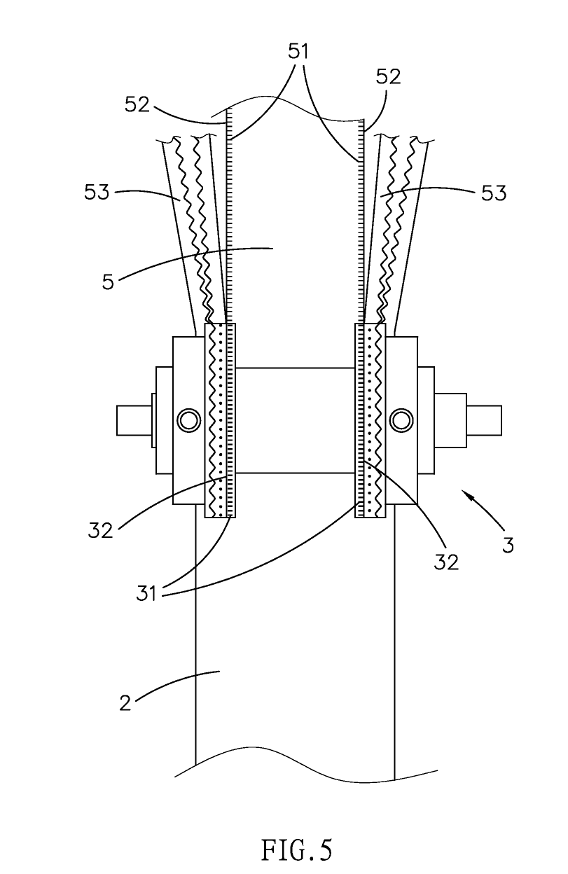

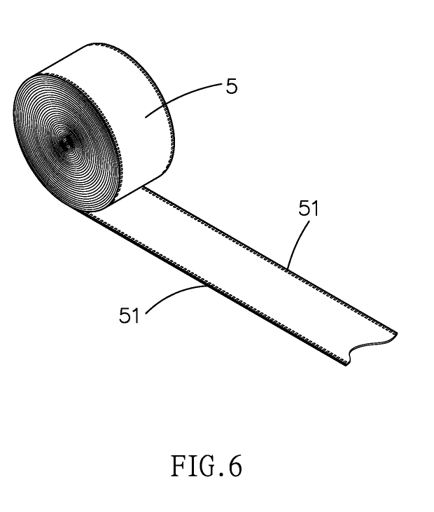

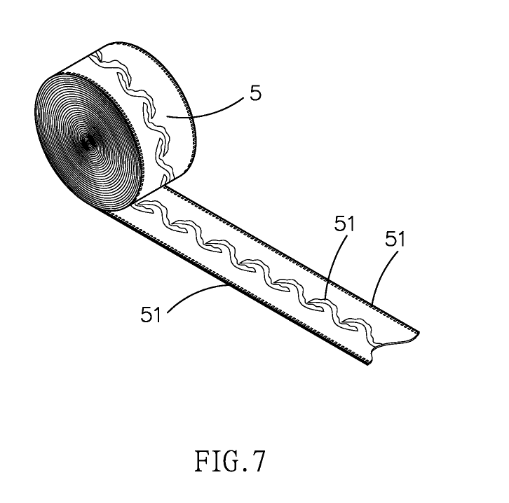

Step 4 (shown in FIG. 5): the lace ribbon 2 is provided under the roller device 3 and corresponding to the two pattern press elements 30 of the roller device 3. When the roller device 3 is heated up, a motor 6 drives the roller device 3 rotate around the roller bearing 34 and the heated patterned model 31 presses and melts corresponding regions of the lace ribbon 2 to form a coining pattern 51 on the lace ribbon 2 according to the pattern of the patterned model 31. At the same time, the heated cutting blade 32 cuts down the excessive portion 53 and rapidly melts two edges 52 of the lace ribbon 2 for sealing. Thus, a patterned lace ribbon 5 (shown in FIG. 6) is formed, having a predetermined continuously coining pattern 51 and the two edges 52. In addition, kinds of patterns can be formed on the patterned lace ribbon 5 (shown in FIG. 7) through designing different patterned model 31 of the roller device 3.

In the manufacturing method, it will be wider the width of the lace fabric 1, higher production of the manufacturing method. Generally, the manufacturing method chooses the lace fabric 1 having a width from 48 to 72 inches and cuts the lace fabric 1 to a lace ribbon 2 having a width less than 2.5 inches. In a preferred embodiment, the lace fabric 1 is 60 inches and the lace fabric 60 is cut to forty strips of lace ribbon 2. Each lace ribbon 2 has a width of 1.5 inches. In conventional manufacturing method, the knitting speeds for the lace fabric 1 and the lace ribbon 2 are similar. According to the testing data, the method according the first embodiment can produce 38 strips of patterned lace ribbons in the period of the conventional method manufacturing one strip of patterned lace ribbon. Thus, the production of the making method according the first embodiment is thirty-eight times more than that of the conventional method.

Therefore, the method of making a lace ribbon according to the first embodiment of the present invention speeds up the production and reduces the cost. In addition, the method can produce all kinds of patterns on the patterned lace ribbon according to the requirements of customer by designing different patterned model, which simplify the manufacturing process.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of making a patterned ribbon comprising:
cutting a fabric to strips of ribbons;
providing a roller device, the roller device comprising a patterned model and a cutting blade; and
providing an ultrasonic device for high frequently oscillating and heating up the roller device;
setting the ribbon under the roller device and driving the roller device to rotate and press the ribbon,
wherein the patterned model presses and melts corresponding regions of the ribbon to form a coining pattern on the ribbon according to a predetermined pattern of the patterned model, the heated cutting blade cuts down the excessive portion of the ribbon, and rapidly melts an edge of the ribbon for sealing.

2. The method of making a patterned ribbon as claimed in claim 1, wherein the fabric is polyester, nylon, metallic or a material knitted by any two of the polyester, the nylon and the metallic.

3. The method of making a patterned ribbon as claimed in claim 1, wherein a force is provided to drive the roller device rotate.

4. The method of making a patterned ribbon as claimed in claim 3, wherein the roller device is driven to rotate by a motor.

5. The method of making a patterned ribbon as claimed in claim 1, wherein the fabric has a width from 48 to 72 inches, and the fabric is cut to the ribbon having a width less than 2.5 inches.

6. The method of making a patterned ribbon as claimed in claim 1, wherein the coining pattern is formed adjacent to the edge of the patterned ribbon.

7. The method of making a patterned ribbon as claimed in claim 1, wherein the coining pattern is formed at center region of the patterned ribbon.

8. The method of making a patterned ribbon as claimed in claim 1, wherein the roller device further comprises a protuberance assembly.

9. The method of making a patterned ribbon as claimed in claim 8, wherein the protuberance assembly has a protruding wall, and a protruding pole between the cutting blade and the protruding wall.

10. The method of making a patterned ribbon as claimed in claim 1, wherein the roller device further comprises a roller bearing, and the patterned model and the cutting blade are set thereon.

11. The method of making a patterned ribbon as claimed in claim 1, wherein the patterned model has a continuous pattern.

12. The method of making a patterned ribbon as claimed in claim 1, wherein the cutting blade is a continuous edge.

13. The method of making a patterned ribbon as claimed in claim 1, wherein the fabric has a width of 60 inches, and the fabric is cut to the ribbon having a width of 1.5 inches.
